(19) United States
(12) Patent Application Publication
(10) Pub. No.: US 2014/0252285 A1
(43) Pub. Date: Sep. 11, 2014

(54) Side Recovery Boom Apparatus for Tow Truck

(71) Applicant: Kelly D. GENOE, Pine Knot, KY (US)

(72) Inventor: Kelly D. GENOE, Pine Knot, KY (US)

(21) Appl. No.: 14/157,172

(22) Filed: Jan. 16, 2014

Related U.S. Application Data
(60) Provisional application No. 61/772,886, filed on Mar. 5, 2013.

(51) Int. Cl. B66D 1/60

(52) U.S. Cl. CPC B66D 1/60
USPC 254/280

(57) ABSTRACT

A side recovery boom for a tow truck, which is attached to a chassis of the tow truck, includes a frame, a boom, a stabilizer arm, and a winch system. The boom which extends in and out of the frame is telescopically connected with a boom track of the frame by a boom hydraulic cylinder, and the stabilizer arm which also extends in and out of the frame is telescopically connected with a stabilizer track of the frame by a stabilizer hydraulic cylinder. The boom allows the frame to be extended so that the immobilized vehicles can be towed from the side of the tow truck while the stabilizer arm counters the moment of rotation created by the boom. The winch system provides the necessary towing power to retrieve the immobilized vehicle as the winch system, the boom, and the stabilizer arm are operated though a control panel.

The current application claims a priority to the U.S. Provisional Patent application Ser. No. 61/772,886 filed on Mar. 5, 2013.

### FIELD OF THE INVENTION

The present invention relates generally to tow trucks which are capable of transporting disabled vehicles as well as retrieving vehicles which have become immobilized. More specifically, the present invention is a side recovery boom for a tow truck which is mounted to the truck near the cab and provides the tow truck with the ability to recovery vehicles that are immobilized directly to the side of the tow truck. This is particularly useful for recovering cars which have slid off the side of the road as often happens in the winter months when inclement weather is commonplace.

### BACKGROUND OF THE INVENTION

Motorized vehicles are easily the most common form of long range transportation in the modern world. In the United States alone there are millions of motorized vehicles, many of which are used by their owners on a daily basis to get to and from their workplace. The act of driving a motor vehicle can be perilous and the dangers involved with piloting a motor vehicle are well known. The most prominent danger faced by any motorist is the danger of crashing their motor vehicle. This can occur in a number of different ways. The motorist can fail the heed traffic laws and find them themselves in a situation where a collision with another vehicle is imminent and unavoidable. Alternatively, the motorist may be put into a situation where the loose control over their vehicle. Losing control of the vehicle may be the result of a mechanical failure, or it may be the result of inclement weather conditions such as rain and snow which can drastically reduce traction on the roads. Whatever the cause of the accident, the results are usually damaging either to the vehicle, the driver, or both.

In some accident cases, the vehicles involved in the accident are damage, but still operational, and can be driven away by their owners. However, in many cases, the vehicles are either disabled, or stuck in a position where they cannot be moved except by an outside force. Motorized vehicles can easily become stuck or slide off the road in inclement weather, especially in the winter months. When this occurs, a tow truck must be utilized to either free the vehicle and return it to the road, or tow the vehicle to a repair shop where the vehicle can be repaired over time. In cases where the motor vehicle is off the side off the road, it can be quite difficult for a standard tow truck to maneuver itself into a position where the rearward boom can be used to pull the vehicle back onto the road. Furthermore there may not be sufficient room on the road for the tow truck to position itself in the required manner without obstructing the other side of the road, causing other vehicles to wait until the process is completed. It is clear that there is a need for an apparatus which would allow tow trucks to more easily retrieve vehicles that have become stuck off the side of the road.

Therefore, it is an object of the present invention to create an apparatus which allows the tow truck to easily recover vehicles that are stuck off the side of the road. It is a further object of the present invention to be compatible with standard tow trucks, allowing the present invention to be mounted to various different trucks with only minor adjustments to the dimensions of the present invention. Additionally, the present invention aims to allow many different designs and models of pulleys, cables, and winches to be mounted to it, thus allowing for different versions of the present invention to be created.

### BRIEF DESCRIPTION OF THE DRAWINGS

FIG. 1 is a perspective view of the present invention.

FIG. 2 is a perspective view of the frame of the present invention.

FIG. 3 is a front view of the frame of the present invention.

FIG. 4 is a perspective view of the boom of the present invention.

FIG. 5 is a side view of the boom of the present invention.

FIG. 6 is a perspective view of the stabilizer arm of the present invention.

FIG. 7 is a side view of the stabilizer arm of the present invention.

FIG. 8 is a front view of the present invention, wherein the broken lines illustrate the boom hydraulic cylinder with the retracted boom and the stabilizer hydraulic cylinder with the retracted stabilizer arm.

FIG. 9 is a front view of the present invention, wherein the broken lines illustrate the boom hydraulic cylinder with the retracted boom and the stabilizer hydraulic cylinder with the extended stabilizer arm.

FIG. 10 is a front view of the present invention, wherein the broken lines illustrate the boom hydraulic cylinder with the extended boom and the stabilizer hydraulic cylinder with the extended stabilizer arm.

FIG. 11 is a basic flow chart illustrating the in fluid communication of the boom hydraulic cylinder, the stabilizer hydraulic cylinder, and the hydraulic pump system and the electrical connections in between the hydraulic pump system, the first winch, the second winch, and the control panel.

### DETAIL DESCRIPTIONS OF THE INVENTION

All illustrations of the drawings are for the purpose of describing selected versions of the present invention and are not intended to limit the scope of the present invention.

The present invention is a side recovery boom for a tow truck that comprises a frame 1, a boom 2, a boom hydraulic cylinder 3, a stabilizer arm 4, a stabilizer hydraulic cylinder 5, and a winch system 6. The side recovery boom is used in conjunction other existing towing types of the tow truck, such as hook and chain, wheel-lift, flatbed, and rear boom, so that the present invention can be specifically used to recover vehicles that are disabled to the side of the road. The present invention is compatible with the standard tow trucks as the present invention can be mounted into the chassis of the tow truck while retaining the existing functionality of the tow truck.

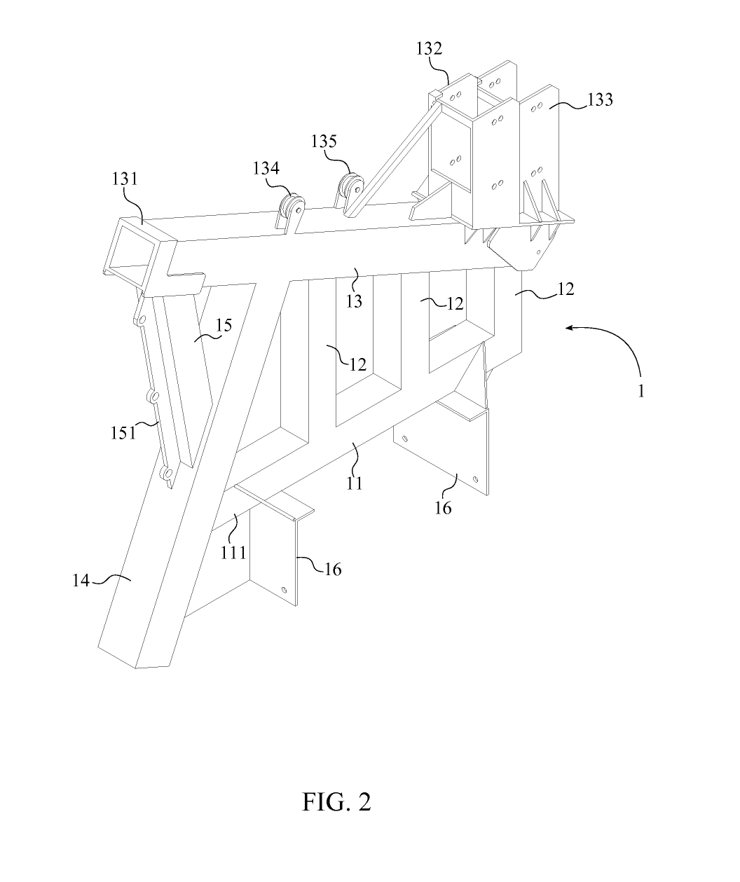

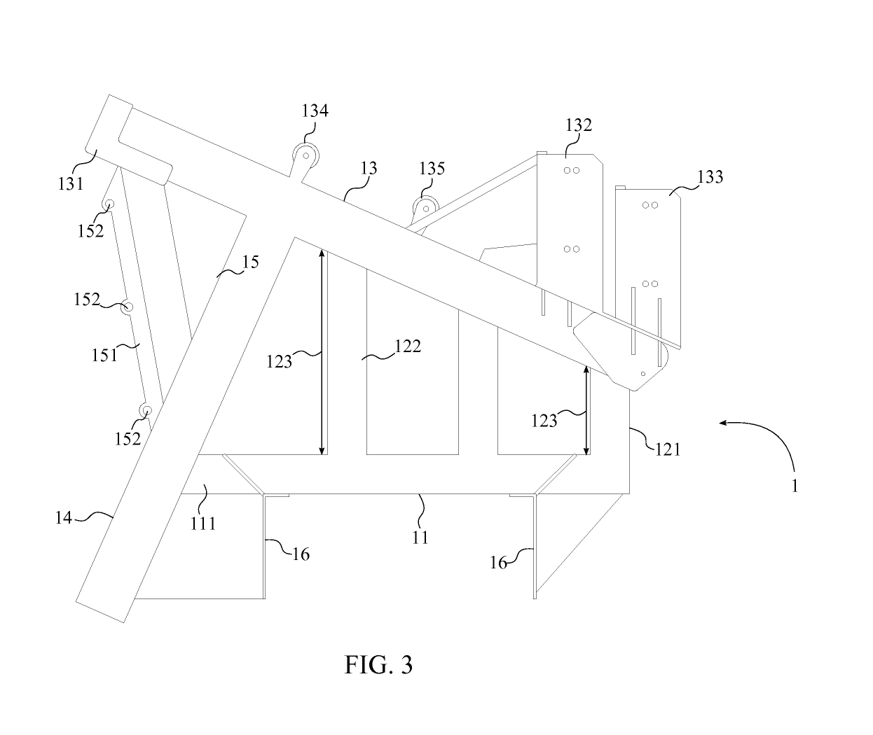

In reference to FIG. 2, the frame 1 comprises a bottom beam 11, a plurality of vertical support beams 12, a boom track 13, a stabilizer track 14, a cross support 15, and a pair of mounting brackets 16. The bottom beam 11 has a square cross section and is generally positioned near the bottom of the present invention as can be seen in FIG. 3. The plurality of vertical support beams 12 is perpendicularly connected with the bottom beam 11, where the plurality of vertical support beams 12 is positioned atop the bottom beam 11. A slanted beam edge 111 of the bottom beam 11 is positioned on the bottom beam 11, where the slanted beam edge 111 is extended away from the plurality of vertical support beams 12. More specifically, the plurality of vertical support beams 12 is distributed along the bottom beam 11 and protruded vertically up from the bottom beam 11, where each of the plurality of vertical support beams 12 has a different height. Similar to the bottom beam 11, the plurality of vertical support beams 12 includes a square cross section. The exact height of each of the plurality of vertical support beams 12 varies depending upon their position relative to the boom track 13. This is because the boom track 13 is angularly positioned relative to the bottom beam 11 as the boom track 13 is connected with the plurality of vertical support beams 12 opposite from the bottom beam 11. The height of each of the plurality of vertical support beams 12 increases as the point of reference travels from the one end of the bottom beam 11 to the opposite end of the bottom beam 11 which is the slanted beam edge 111. The purpose of the plurality of vertical support beams 12 is to support the boom track 13 which houses the boom 2. The plurality of vertical support beams 12 is necessary within the present invention since a large downward force is experienced by the boom 2 and subsequently the boom track 13, where the plurality of vertical support beams 12 bears this downward load. The presence of the plurality of vertical support beams 12 prevents the boom track 13 from being subjected to a high bending moment which could cause the boom track 13 to fail if it was not properly supported by the plurality of vertical support beams 12.

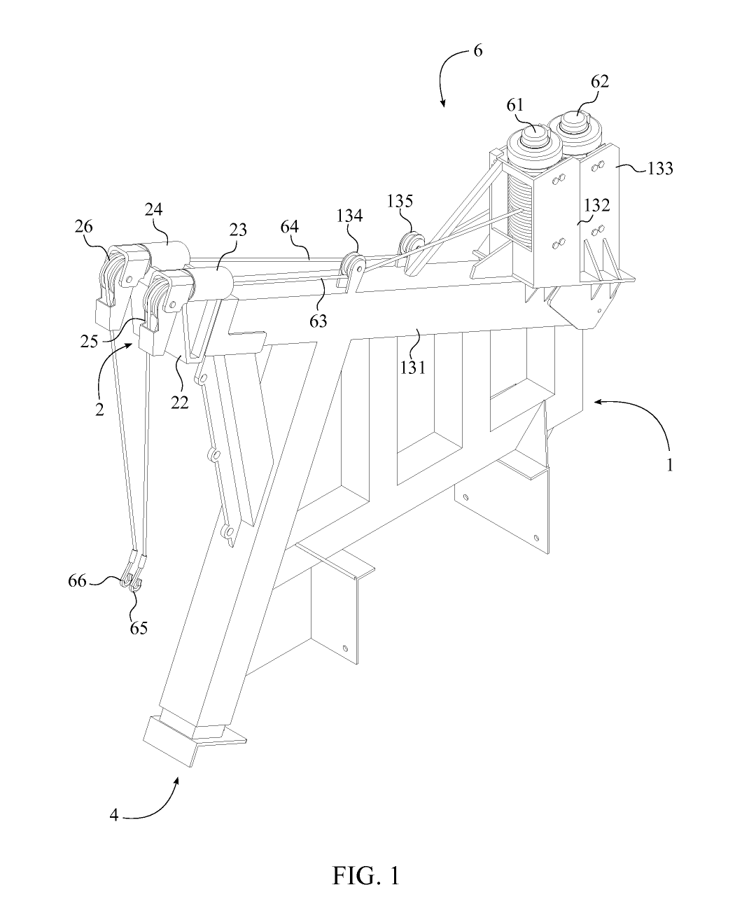

In reference to FIG. 1, the boom track 13 which is angularly supported by the plurality of vertical support beams 12 is a long hollow tube with a square cross section and comprises a track edge 131, a first winch mount 132, a second winch mount 133, a first guide pulley 134, and a second guide pulley 135. The primary purpose of the boom track 13 is to allow the boom 2 to be engaged to the frame 1 in a manner such the boom 2 may slide in and out of the boom track 13. The track edge 131 is positioned on the boom track 13 as the track edge 131 is extended away from the plurality of vertical support beams 12. The first winch mount 132 and the second winch mount 133 are connected on the boom track 13, where the first winch mount 132 and the second winch mount 133 are oppositely positioned from the plurality of vertical support beams 12. The first winch mount 132 and the second winch mount 133 are also oppositely positioned from the track edge 131 along the boom track 13 in such way that the first winch mount 132 and the second winch mount 133 are offset from one another. The first winch mount 132 and the second winch mount 133 each comprise a plurality of structural supports as can be seen in FIG. 2, where the purpose of the plurality of structural supports is to reinforce the first winch mount 132 and the second winch mount 133 with the boom track 13 and prevent any failures due to loading experienced by those components. In the preferred embodiment, the first winch mount 132 and the second winch mount 133 each comprise a pair of plates which extends vertically upward from the boom track 13, where the pair of plates is aligned vertically despite the angled alignment of the boom track 13. The first guide pulley 134 and the second guide pulley 135 are connected on the boom track 13 opposite from the plurality of vertical support beams 12. More specifically, the first guide pulley 134 is linearly positioned in between the first winch mount 132 and the track edge 131, and the second guide pulley 135 is linearly positioned in between the second winch mount 133 and the track edge 131. The first guide pulley 134 and the second guide pulley 135 each comprise a pair of tab which is protruded upward from the boom track 13. The pair of tabs, which is separated by some distance, houses a rotatable pulley via a fastener so that the first guide pulley 134 and the second guide pulley 135 of the boom track 13 can be utilized within the present invention.

In reference to FIG. 3, the stabilizer track 14 is perpendicularly connected with the boom track 13 in between the plurality of vertical support beams 12 and the track edge 131, where the stabilizer track 14 is adjacently connected with the slanted beam edge 111. The stabilizer track 14 is a hollow tube and possesses a square cross section much like the boom track 13. Alignment of the stabilizer track 14 is optimized to ensure that the stabilizer arm 4 can provide maximum support to the boom track 13 as the stabilizer arm 4 is housed within the stabilizer track 14.

In reference to FIG. 3, the plurality of vertical support beams 12 comprises a proximal support beam 121 and a distal support beam 122, where the distal support beam 122 is adjacently positioned with the stabilizer track 14 and the proximal support beam 121 is adjacently positioned with the distal support beam 122 opposite from the stabilizer track 14. The proximal support beam 121 and the distal support beam 122 both comprise a height 123, where the height 123 for the proximal support beam 121 and the distal support beam 122 is positioned from the boom track 13 to the bottom beam 11. Due to the angular position of the boom track 13 with respect the bottom beam 11 and the height 123 difference of each of the plurality of vertical support beams 12, the height 123 of the proximal support beam 121 is smaller than the height 123 of the distal support beam 122. The exact angle of alignment of the boom track 13 with respect to the bottom beam 11 may vary depending upon the design requirements and load distributions that are desired in final manufacturing of the present invention.

In reference to FIG. 3, the cross support 15 that comprises a ridge 151 and a plurality of holes 152 is connected in between the boom track 13 and the stabilizer track 14. More specifically, the ridge 151 is positioned along the cross support 15 from the boom track 13 to the stabilizer track 14 as the ridge 151 protrudes out of the cross support 15 with a relatively small thickness. The plurality of holes 152 is traversed through the ridge 151 so that the plurality of holes 152 can provide a place to secure some of the components of the winch system 6. The cross support 15 has a square cross section and is aligned at some angle relative to the boom track 13 and the stabilizer track 14. The exact angle of alignment and the length of the cross support 15 may vary depending upon the design requirements of the present invention and the amount of support that is necessary for the boom track 13 so that the bending stress experience by the boom track 13 can be overcome through the cross support 15.

In reference to FIG. 2, the pair of mounting brackets 16 is connected to the bottom beam 11 in such way that the pair of mounting brackets 16 is oppositely positioned from the plurality of vertical support beams 12. The pair of mounting brackets 16 is oppositely positioned from each other along the bottom beam 11 so that the pair of mounting brackets 16 allows the present invention to be securely mounted to the chassis of the tow truck by a plurality of fasteners 9, as it is necessary for the present invention to be fully utilized. The space between the pair of mounting brackets 16 must be sufficient spacing such that the chassis of the tow truck is able fit between the pair of mounting brackets 16. Ideally, the pair of mounting brackets 16 should be flushed with the chassis of the tow truck so that the most secure connection between the chassis of the tow truck and the frame 1 of the present invention can be achieved through the plurality of fasteners 9. The pair of mounting brackets 16 comprises a plurality of bracket supports, where the plurality of bracket supports ensures that the loadings experience by the present invention during use of the present invention are properly transferred into the pair of mounting brackets 16 and subsequently to the tow truck without over stressing the junctions between the components of the present invention. In structural devices like the frame 1, the weakest points are often the junctions, where the components are often welded together. As a result, it is important to keep as much of the loadings experience by the present invention within the components of the present invention as opposed to the connections between the components. In the preferred embodiment of the present invention, L shaped brackets are used as the pair of mounting brackets 16 and a plurality of nuts and bolts is used as the plurality of fasteners 9. More specifically, the plurality of bolts is inserted through a plurality of fastener holes of the L shaped brackets and a plurality of frame holes of the chassis of the tow truck as the plurality of nuts secures the plurality of bolts so that secure connections can be utilized in between the present invention and the chassis of the tow truck. The plurality of fastener holes is pre-drilled within the L shaped brackets, and the plurality of frame holes needs to be drill during the installation of the present invention so that the plurality of fasteners 9 can be inserted. The plurality of fastener holes assists the users of the present invention to correctly drill the plurality of frame holes, where the plurality of fastener holes functions as a template for the plurality of frame holes.

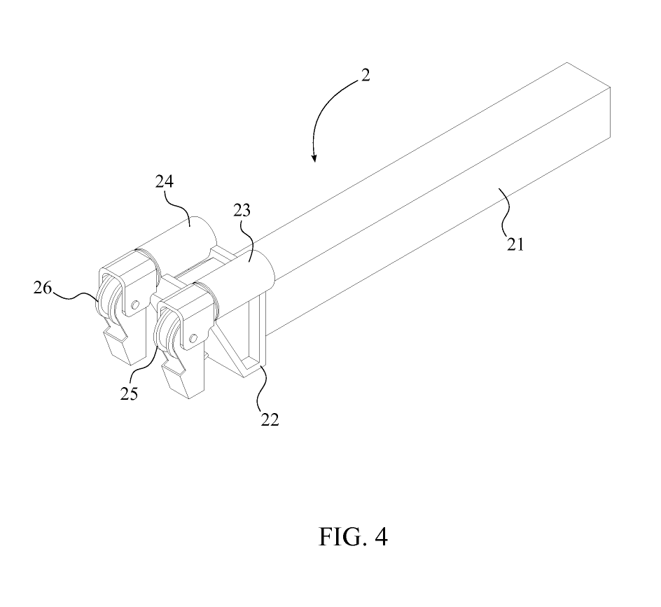

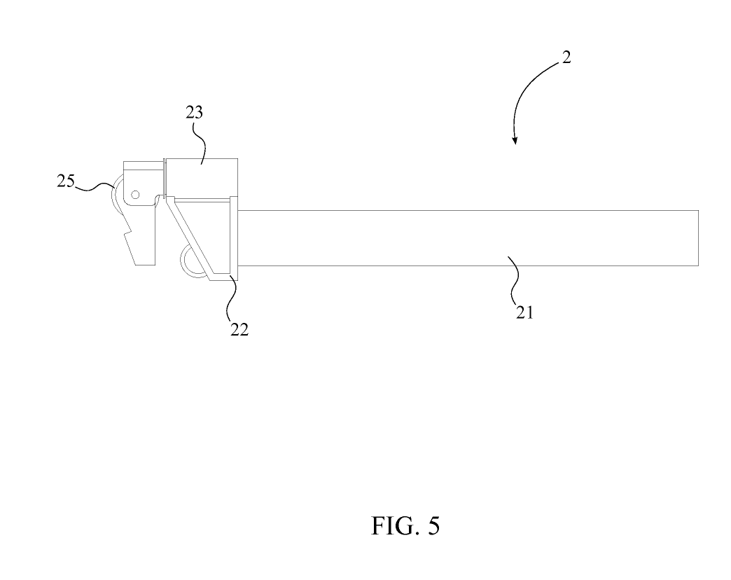

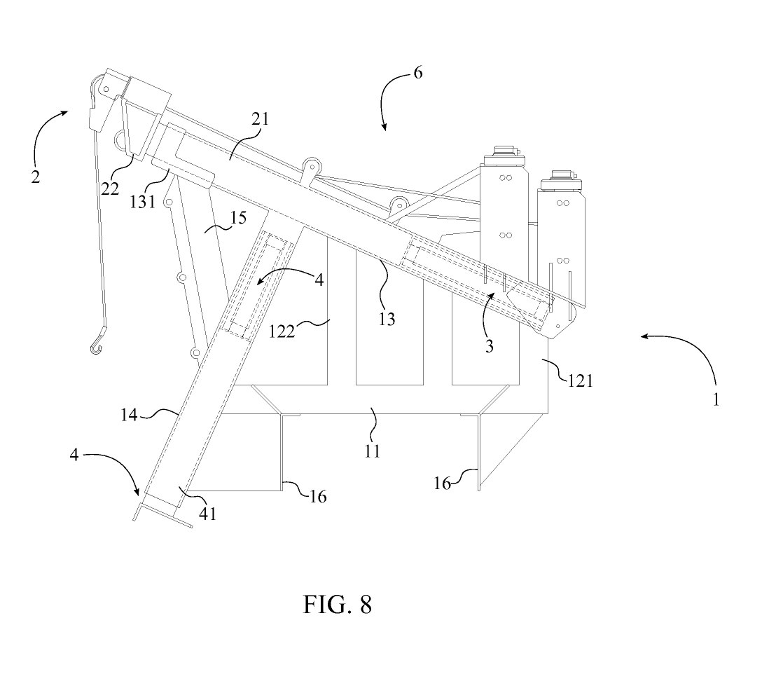

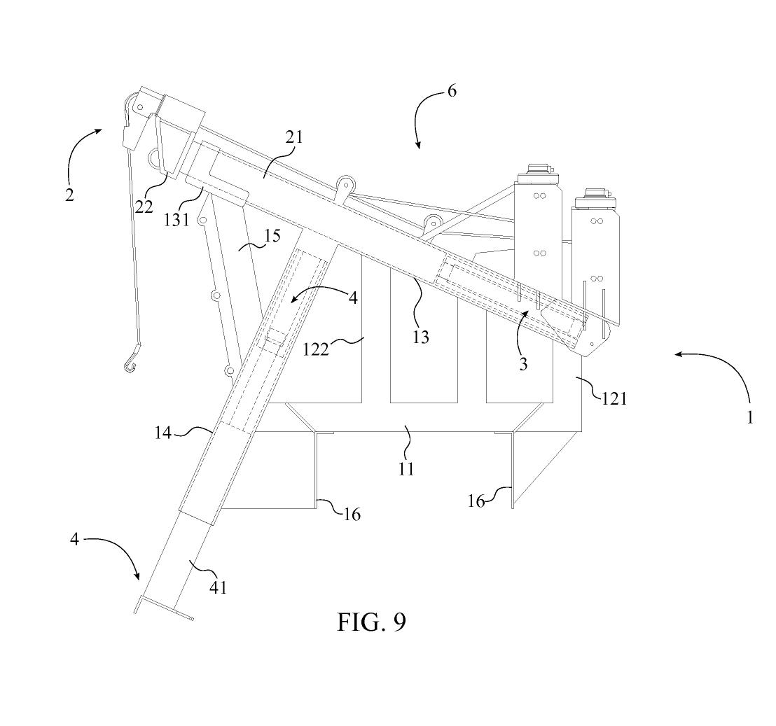

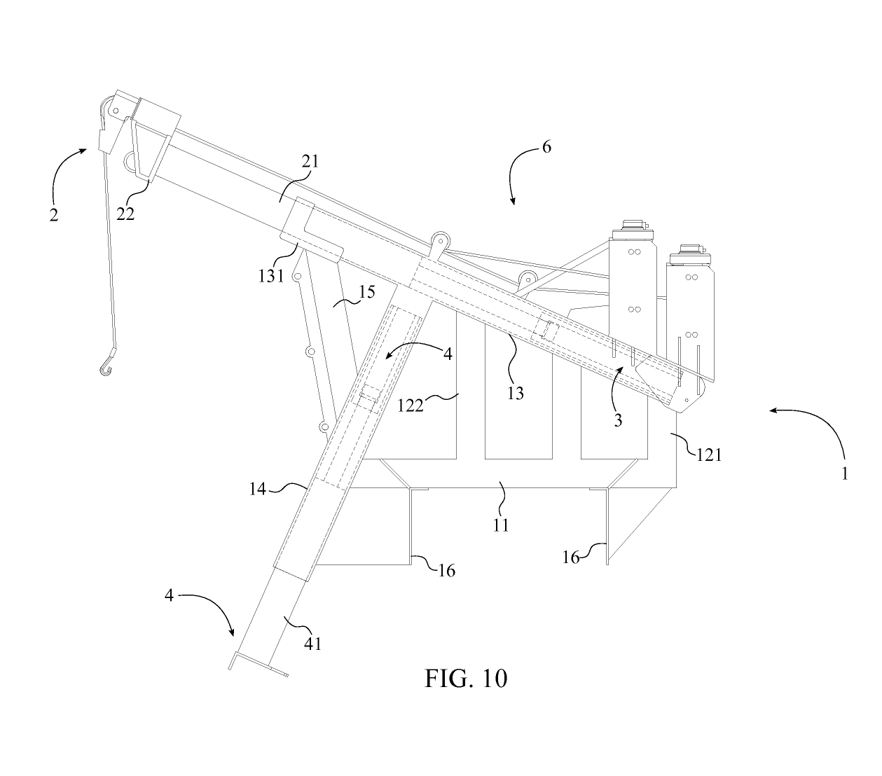

In reference to FIG. 4 and FIG. 5, the boom 2 that extends in and out of the boom track 13 comprises an actuator beam 21, a beam head 22, a first pulley tube 23, a second pulley tube 24, a first directional pulley 25, and a second directional pulley 26. The beam head 22 is concentrically connected with the actuator beam 21, where the actuator beam 21 is a square cross sectioned beam that fits within the boom track 13. The first pulley tube 23 is connected to the beam head 22, and the second pulley tube 24 is connected to the beam head 22 opposite from the first pulley tube 23. The first directional pulley 25 is articulately connected with the first pulley tube 23 in such way that the first directional pulley 25 is oppositely positioned from the actuator beam 21. Similarly, the second directional pulley 26 is articulately connected with the second pulley tube 24 in such way that the second directional pulley 26 is oppositely positioned from the actuator beam 21. The connection between the boom 2 and the boom track 13 is shown in FIG. 8-FIG. 10, where the actuator beam 21 is sleeved by the boom track 13 in such way that the actuator beam 21 is telescopically connected with the boom track 13 by the boom hydraulic cylinder 3. The boom hydraulic cylinder 3 possesses the power to extend the boom 2 and prevent the boom 2 from retracting when the present invention is used.

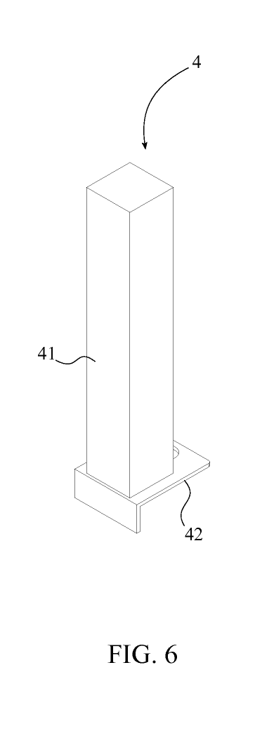

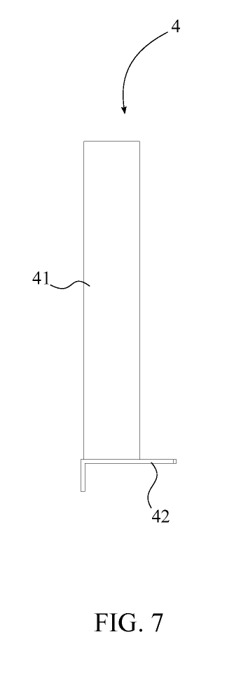

In reference to FIG. 6 and FIG. 7, the stabilizer arm 4 comprises an actuator arm 41 and a base 42, where the base 42 is adjacently connected with the actuator arm 41. The actuator arm 41 has a square cross section and needs to fit within the stabilizer track 14 for the functionality of the stabilizer arm 4. The length of the actuator arm 41 may vary depending upon the design requirements of the present invention, particularly the height of the tow truck onto which the present invention is mounted. The purpose of the stabilizer arm 4 is to make contact with the ground some horizontal distance away from the present invention. The reasoning for this is to ensure that the tow truck does not roll over as a result of heavy loads that are experience by the boom 2 during the use of the present invention. The distance of the loading from the tow truck as caused by the use of the boom 2 generates a significant moment about the tow truck. For example, if a high enough moment is created by the boom 2, the moment could easily roll the tow truck over. The stabilizer arm 4 is used to prevent this from happening. The stabilizer arm 4 must make contact with the ground in such way that the base 42 is in contact with the ground in order to counter the moment. The base 42 is intended to ensure a high traction interface between the actuator arm 41 and the ground. The connection between the stabilizer arm 4 and the stabilizer track 14 is shown in FIG. 8-FIG. 10, where the actuator arm 41 is sleeved by the stabilizer track 14 in such way that the actuator arm 41 is telescopically connected with the stabilizer track 14 by the stabilizer hydraulic cylinder 5. The stabilizer hydraulic cylinder 5 possesses the power to extend the stabilizer arm 4 and prevent the stabilizer arm 4 from retracting when the present invention is used.

In reference to FIG. 1, the winch system 6 provides the present invention with the ability to extract incredibly high forces and comprises a first winch 61, a second winch 62, a first winch cable 63, a second winch cable 64, a first winch hook 65, and a second winch hook 66. The first winch 61 and the second winch 62 are respectively attached within the first winch mount 132 and the second winch mount 133 through a plurality of winch fasteners. The exact configuration and size of the first winch 61 and the second winch 62 may vary greatly, however the basic concept remains the same no matter what kind of winches are used. The first winch 61 and the second winch 62 capable of retracting a cable around a spool even when the cable is bearing and extremely high load. To accomplish this process, the first winch 61 and the second winch 62 each utilizes an electric motor which is capable of generating incredibly high amounts of torque, enabling the first winch 61 and the second winch 62 to reel in extremely heavy loads.

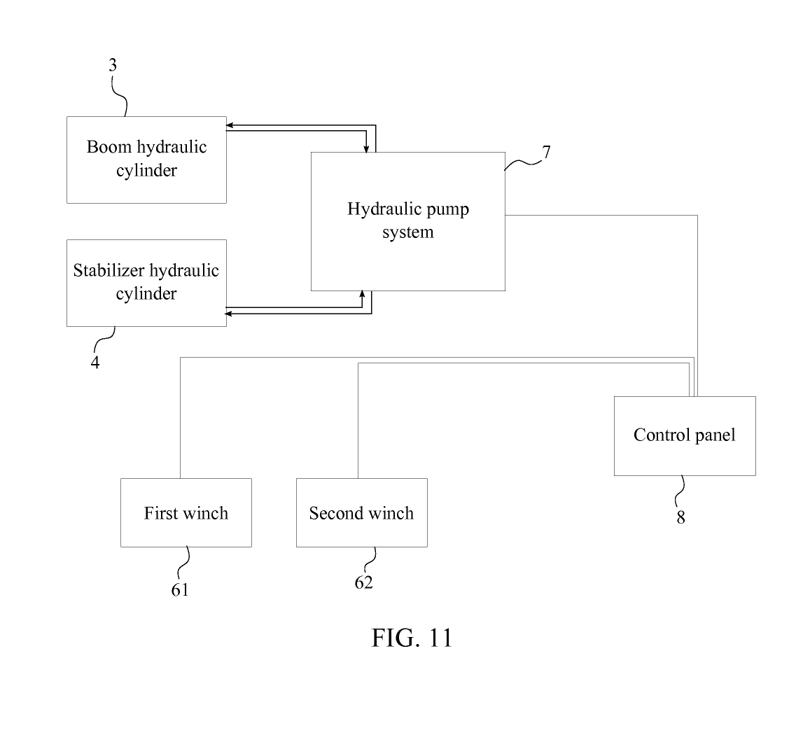

In reference to FIG. 11, the first winch 61 and the second winch 62 are electrically connected with a control panel 8 so that the first winch 61 and the second winch 62 can be independently controlled through the control panel 8. The boom hydraulic cylinder 3 and the stabilizer hydraulic cylinder 5 are in fluid communication with a hydraulic pump system 7, where the hydraulic pump system 7 is electrically connected with the control panel 8. The electrical connection between the hydraulic pump system 7 and the control panel 8 allows the users of the present invention to individually operate the boom hydraulic cylinder 3 and the stabilizer hydraulic cylinder 5. Since the first winch 61, the second winch 62, the boom hydraulic cylinder 3, and the stabilizer hydraulic cylinder 5 are controlled through the control panel 8, the control panel 8 is preferably located on the frame 1 of the present invention. The exact location of the control panel 8 can differ depending on different embodiments of the present invention as long as the control panel 8 can be easily accessed and operated by the users of the present invention.

In reference to FIG. 1, the first winch cable 63 is tangentially connected with the first winch 61 adjacent to the first winch mount 132 from one end and connected with the first winch hook 65 adjacent to the first directional pulley 25 from the opposite end. From the first winch 61 to the first winch hook 65, the first winch cable 63 is perimetrically engaged around the first guide pulley 134, traversed through the first pulley tube 23, and perimetrically engaged around the first directional pulley 25. Similarly, the second winch cable 64 is tangentially connected with the second winch 62 adjacent to the second winch mount 133 from one end and connected with the second winch hook 66 adjacent to the second directional pulley 26 from the opposite end. From the second winch 62 to the second winch hook 66, the second winch cable 64 is perimetrically engaged around the second guide pulley 135, traversed through the second pulley tube 24, and perimetrically engaged around the second directional pulley 26. The first guide pulley 134 and the second guide pulley 135 ensure that the first winch cable 63 and the second winch cable 64 separately extend along the boom track 13 without becoming entangled with each other. The first pulley tube 23 and the second pulley tube 24 ensure that the first winch cable 63 and the second winch cable 64 separately extend along the actuator beam 21 without becoming entangled with each other. The first directional pulley 25 and the second directional pulley 26 ensure that the first winch cable 63 and the second winch cable 64 separately extend along the beam head 22 without becoming entangled with each other.

The first directional pulley 25 and the second directional pulley 26 rotate relative to the central axis of the boom 2 due to the articulated connection within the first pulley tube 23 and the second pulley tube 24. This is an important function as the first winch cable 63 and the second winch cable 64, which are respectively extended form the first winch 61 and the second winch 62, are proceed straight up through and out of the beam head 22 immediately after which point the first winch cable 63 and the second winch cable 64 may angle off in another direction. This is significant as when a vehicle is recovered from sliding off the road, the vehicle needs to be secured with at least two points to ensure full control. As a result, the first winch cable 63 and the second winch cable 64 can have different angles from the reference point of the boom 2, but the first directional pulley 25 and the second directional pulley 26 ensure that the first winch cable 63 and the second winch cable 64 can be safely angled without risk of entanglement or misalignment when the present invention is in use.

In the event of recovering a disable vehicle, the first winch hook 65 and the second winch hook 66 are properly positioned with the disable vehicle through the boom 2 so that the disable vehicle can be retrieved to a safer location. When the winch system 6 is not used within the present invention, the first winch hook 65 and the second winch hook 66 can be secured within the plurality of holes 152. It is important that the first winch hook 65 and the second winch hook 66 are secured to the ridge 151 when the tow truck is in motion such that the first winch cable 63 and the second winch cable 64 do not swing around and cause damage to the tow truck, the components of the present invention, and the surrounding vehicles.

Although the invention has been explained in relation to its preferred embodiment, it is to be understood that many other possible modifications and variations can be made without departing from the spirit and scope of the invention as hereinafter claimed.

What is claimed is:

1. A side recovery boom apparatus for tow truck comprises:
a frame;
a boom;
a boom hydraulic cylinder;
a stabilizer arm;
a stabilizer hydraulic cylinder;
a winch system;
the frame comprises a bottom beam, a plurality of vertical support beams, a boom track, a stabilizer track, a cross support, and a pair of mounting brackets;
the boom comprises an actuator beam, a beam head, a first pulley tube, a second pulley tube, a first directional pulley, a second directional pulley;
the stabilizer arm comprises an actuator arm and a base; and
the winch system comprises a first winch, a second winch, a first winch cable, a second winch cable, a first winch hook, and a second winch hook.

2. The side recovery boom apparatus for tow truck as claimed in claim 1 comprises:
the plurality of vertical support beams being perpendicularly connected with the bottom beam;
the plurality of vertical support beams being positioned atop the bottom beam;
the boom track being connected with the plurality of vertical support beams opposite from the bottom beam;
the boom track being angularly positioned with the bottom beam;
a slanted beam edge of the bottom beam being extended away from the plurality of vertical support beams;
a track edge of the boom track being extended away from the plurality of vertical support beams;
the stabilizer track being perpendicularly connected with the boom track in between the plurality of vertical support beams and the track edge;
the stabilizer track being adjacently connected with the slanted beam edge;
the cross support being connected in between the boom track and the stabilizer track;
the pair of mounting brackets being connected with the bottom beam;
the pair of mounting brackets being oppositely positioned from each other along the bottom beam; and
the pair of mounting brackets being oppositely positioned from the plurality of vertical support beams.

3. The side recovery boom apparatus for tow truck as claimed in claim 2 comprises:
the plurality of vertical support beams comprises a proximal support beam and a distal support beam;
the distal support beam being adjacently positioned with the stabilizer track;
the proximal support beam being adjacently positioned with the distal support beam opposite from the stabilizer track;
a height for the proximal support beam being positioned from the boom track to the bottom beam;
a height for the distal support beam being positioned from the boom track to the bottom beam; and
the height of the proximal support beam being smaller than the height of the distal support beam.

4. The side recovery boom apparatus for tow truck as claimed in claim 2 comprises:
the boom track comprises a first winch mount, a second winch mount, a first guide pulley, and a second guide pulley;
the first winch mount and the second winch mount being connected on the boom track;
the first winch mount and the second winch mount being oppositely positioned from the plurality of vertical support beams;
the first winch mount and the second winch mount being oppositely positioned from the track edge along the boom track;
the first winch mount being offset from the second winch mount;
the first guide pulley and the second guide pulley being connected on the boom track opposite from the plurality of vertical support beams;
the first guide pulley being linearly positioned in between the first winch mount and the track edge; and
the second guide pulley being linearly positioned in between the second winch mount and the track edge.

5. The side recovery boom apparatus for tow truck as claimed in claim 2 comprises:
the cross support comprises a ridge and a plurality of holes;
the ridge being positioned along the cross support; and
the plurality of holes traversing through the ridge.

6. The side recovery boom apparatus for tow truck as claimed in claim 1 comprises:
the beam head being concentrically connected with the actuator beam;
the first pulley tube being connected to the beam head;
the second pulley tube being connected to the beam head opposite from the first pulley tube;
the first directional pulley being articulately connected with the first pulley tube;
the first directional pulley being oppositely positioned from the actuator beam;
the second directional pulley being articulately connected with the second pulley tube; and
the second directional pulley being oppositely positioned from the actuator beam.

7. The side recovery boom apparatus for tow truck as claimed in claim 1 comprises:
the actuator beam being sleeved by the boom track; and
the actuator beam being telescopically connected with the boom track by the boom hydraulic cylinder.

8. The side recovery boom apparatus for tow truck as claimed in claim 1 comprises:
the base being adjacently connected with the actuator arm;
the actuator arm being sleeved by the stabilizer track; and
the actuator beam being telescopically connected with the stabilizer track by the stabilizer hydraulic cylinder.

9. The side recovery boom apparatus for tow truck as claimed in claim 1 comprises:
the first winch being attached within the first winch mount;
the first winch cable is tangentially connected with the first winch adjacent to the first winch mount;
the first winch cable being perimetrically engaged around the first guide pulley;
the first winch cable traversing through the first pulley tube;
the first winch cable being perimetrically engaged around the first directional pulley; and
the first winch cable being connected with the first winch hook adjacent to the first directional pulley.

10. The side recovery boom apparatus for tow truck as claimed in claim 1 comprises:
the second winch being attached within the second winch mount;
the second winch cable is tangentially connected with the second winch adjacent to the second winch mount;
the second winch cable being perimetrically engaged around the second guide pulley;
the second winch cable traversing through the second pulley tube;
the second winch cable being perimetrically engaged around the second directional pulley; and
the second winch cable being connected with the second winch hook adjacent to the second directional pulley.

11. The side recovery boom apparatus for tow truck as claimed in claim 1 comprises:
the first winch being electrically connected with a control panel;
the second winch being electrically connected with the control panel;
the boom hydraulic cylinder and the stabilizer hydraulic cylinder being in fluid communication with a hydraulic pump system; and
the hydraulic pump system being electrically connected with the control panel.

12. The side recovery boom apparatus for tow truck as claimed in claim 1, wherein the pair of mounting brackets is attached to a tow truck chassis.

13. A side recovery boom apparatus for tow truck comprises:
a frame;
a boom;
a boom hydraulic cylinder;
a stabilizer arm;
a stabilizer hydraulic cylinder;
a winch system;
the frame comprises a bottom beam, a plurality of vertical support beams, a boom track, a stabilizer track, a cross support, and a pair of mounting brackets;
the boom comprises an actuator beam, a beam head, a first pulley tube, a second pulley tube, a first directional pulley, a second directional pulley;
the stabilizer arm comprises an actuator arm and a base;
the winch system comprises a first winch, a second winch, a first winch cable, a second winch cable, a first winch hook, and a second winch hook;
the plurality of vertical support beams being perpendicularly connected with the bottom beam;
the plurality of vertical support beams being positioned atop the bottom beam;
the boom track being connected with the plurality of vertical support beams opposite from the bottom beam;
the boom track being angularly positioned with the bottom beam;
a slanted beam edge of the bottom beam being extended away from the plurality of vertical support beams;
a track edge of the boom track being extended away from the plurality of vertical support beams;
the stabilizer track being perpendicularly connected with the boom track in between the plurality of vertical support beams and the track edge;
the stabilizer track being adjacently connected with the slanted beam edge;
the cross support being connected in between the boom track and the stabilizer track;
the pair of mounting brackets being connected with the bottom beam;
the pair of mounting brackets being oppositely positioned from each other along the bottom beam; and
the pair of mounting brackets being oppositely positioned from the plurality of vertical support beams, wherein the pair of mounting brackets is attached to a tow truck chassis.

14. The side recovery boom apparatus for tow truck as claimed in claim 13 comprises:
the plurality of vertical support beams comprises a proximal support beam and a distal support beam;
the distal support beam being adjacently positioned with the stabilizer track;
the proximal support beam being adjacently positioned with the distal support beam opposite from the stabilizer track;
a height for the proximal support beam being positioned from the boom track to the bottom beam;
a height for the distal support beam being positioned from the boom track to the bottom beam; and
the height of the proximal support beam being smaller than the height of the distal support beam.

15. The side recovery boom apparatus for tow truck as claimed in claim 13 comprises:
the boom track comprises a first winch mount, a second winch mount, a first guide pulley, and a second guide pulley;
the first winch mount and the second winch mount being connected on the boom track;
the first winch mount and the second winch mount being oppositely positioned from the plurality of vertical support beams;
the first winch mount and the second winch mount being oppositely positioned from the track edge along the boom track;
the first winch mount being offset from the second winch mount;
the first guide pulley and the second guide pulley being connected on the boom track opposite from the plurality of vertical support beams;
the first guide pulley being linearly positioned in between the first winch mount and the track edge; and
the second guide pulley being linearly positioned in between the second winch mount and the track edge.

16. The side recovery boom apparatus for tow truck as claimed in claim 13 comprises:
the cross support comprises a ridge and a plurality of holes;
the ridge being positioned along the cross support; and
the plurality of holes traversing through the ridge.

17. The side recovery boom apparatus for tow truck as claimed in claim 13 comprises:
the beam head being concentrically connected with the actuator beam;
the first pulley tube being connected to the beam head;
the second pulley tube being connected to the beam head opposite from the first pulley tube;
the first directional pulley being articulately connected with the first pulley tube;
the first directional pulley being oppositely positioned from the actuator beam;
the second directional pulley being articulately connected with the second pulley tube; and
the second directional pulley being oppositely positioned from the actuator beam.

18. The side recovery boom apparatus for tow truck as claimed in claim 13 comprises:
the actuator beam being sleeved by the boom track;
the actuator beam being telescopically connected with the boom track by the boom hydraulic cylinder;
the base being adjacently connected with the actuator arm;
the actuator arm being sleeved by the stabilizer track; and
the actuator beam being telescopically connected with the stabilizer track by the stabilizer hydraulic cylinder.

19. The side recovery boom apparatus for tow truck as claimed in claim 13 comprises:
the first winch being attached within the first winch mount;
the first winch cable is tangentially connected with the first winch adjacent to the first winch mount;
the first winch cable being perimetrically engaged around the first guide pulley;
the first winch cable traversing through the first pulley tube;
the first winch cable being perimetrically engaged around the first directional pulley;
the first winch cable being connected with the first winch hook adjacent to the first directional pulley;
the second winch being attached within the second winch mount;
the second winch cable is tangentially connected with the second winch adjacent to the second winch mount;
the second winch cable being perimetrically engaged around the second guide pulley;
the second winch cable traversing through the second pulley tube;
the second winch cable being perimetrically engaged around the second directional pulley; and
the second winch cable being connected with the second winch hook adjacent to the second directional pulley.

20. The side recovery boom apparatus for tow truck as claimed in claim 13 comprises:
the first winch being electrically connected with a control panel;
the second winch being electrically connected with the control panel;
the boom hydraulic cylinder and the stabilizer hydraulic cylinder being in fluid communication with a hydraulic pump system; and
the hydraulic pump system being electrically connected with the control panel.
